(19) United States
(12) Patent Application Publication
(10) Pub. No.: US 2012/0134087 A1
(43) Pub. Date: May 31, 2012

(54) RACK SERVER DEVICE

(75) Inventor: Sing-Hao PENG, TAIPEI CITY (TW)

(73) Assignee: INVENTEC CORPORATION, TAIPEI CITY (TW)

(21) Appl. No.: 13/074,030

(22) Filed: Mar. 29, 2011

(30) Foreign Application Priority Data
Nov. 30, 2010 (TW) 099141505

(51) Int. Cl. G06F 1/16

(52) U.S. Cl. 361/679.02

(57) ABSTRACT

A rack server device includes a rack, a plurality of servers, and a plurality of power distribution units (PDU). The servers are configured on the rack. Each of the servers includes a power supply, and the power supply includes a plug. The plug includes a positive pin, a negative pin, a ground pin, and a signal pin, wherein the signal pin is shorter than the positive pin, the negative pin and the ground pin. The PDUs are configured on the rack. Each of the PDUs includes a socket. The socket includes a positive connecting port, a negative connecting port, a ground connecting port, and a signal connecting port. The positive connecting port, the negative connecting port, the ground connecting port, and the signal connecting port are operable to connect to the positive pin, the negative pin, the ground pin, and the signal pin respectively.

### RELATED APPLICATIONS

This application claims priority to Taiwan Application Serial Number 099141505, filed Nov. 30, 2010, which is herein incorporated by reference.

### BACKGROUND

1. Field of Invention

The present invention relates to a server device, and more particularly to a rack server device with a hot-swap function.

2. Description of Related Art

In a conventional data center, a power distribution unit (PDU) is connected with a power supply of a server by using a power cord.

However, power input ends of servers, storage apparatuses and switches in a rack server device are all disposed at a rear side thereof and need to be connected by using the power cord. Thus, during repairing or disassembling, the power cord disposed at the rear side of the server should be first detached, and then the server can be pulled out of the rack.

In order to make it convenient for a user to repair or disassemble the server, there is still room for further improving the design of the server.

### SUMMARY

Therefore, an objective of the present invention provides a rack server device to solve the problem that a spark is produced when a server is directly pulled out of a rack.

In order to achieve the above objective, an aspect of the present invention relates to the rack server device, which includes a rack, a plurality of servers and a plurality of power distribution units (PDUs). The plurality of servers are configured on the rack. Each of the servers includes a power supply, and the power supply includes a power connecting plug. The power connecting plug includes a positive pin, a negative pin, a ground pin, and a signal pin, wherein the signal pin is shorter than the positive pin, the negative pin and the ground pin. The PDUs are configured on the rack. Each of the PDUs includes a power connecting socket. The power connecting socket includes a positive connecting port, a negative connecting port, a ground connecting port, and a signal connecting port. The positive connecting port, the negative connecting port, the ground connecting port, and the signal connecting port are operable to respectively connect to the positive pin, the negative pin, the ground pin, and the signal pin.

According to an embodiment of the present invention, when the power connecting plug is connected with the power connecting socket, the signal pin is connected with the signal connecting port and meanwhile the power supply provides power to the corresponding server, and when the power connecting plug is pulled out of the power connecting socket, the signal pin is disconnected from the signal connecting port and meanwhile the power supply stops providing power to the corresponding server.

According to another embodiment of the present invention, each of the servers further includes a microcontroller. The microcontroller is operable to control the power supplies. When the signal pin is connected with the signal connecting port, a connection signal is produced, and when the microcontroller receives a ground signal, the microcontroller controls the power supply to make it provide power to the corresponding server.

According to yet another embodiment of the present invention, when the power connecting plug is pulled out of the power connecting socket, the connection signal disappears, and when the microcontroller does not receive the connection signal, the microcontroller controls the power supply to stop providing power to the corresponding server.

In order to achieve the above objectives, another technical aspect of the present invention relates to a rack server device, which includes a rack, a plurality of servers and a plurality of power distribution units (PDUs). The servers are configured on the rack. Each of the servers includes a power supply, and the power supply includes a power connecting plug which includes a signal pin. Each of the power connecting sockets includes a signal connecting port.

Furthermore, when the power connecting plug is connected with the power connecting socket, the signal pin is connected with the signal connecting port and meanwhile the power supply provides power to the corresponding server.

According to an embodiment of the present invention, when the power connecting plug is pulled out of the power connecting socket, the signal pin is disconnected from the signal connecting port and meanwhile the power supply stops providing power to the corresponding server.

According to another embodiment of the present invention, the power connecting plug further includes a positive pin, a negative pin and a ground pin, wherein the signal pin is shorter than the positive pin, the negative pin and the ground pin.

According to another embodiment of the present invention, the power connecting socket further includes a positive connecting port, a negative connecting port and a ground connecting port.

According to another embodiment of the present invention, each of the servers further includes a microcontroller. The microcontroller is operable to control the power supply. When the signal pin is connected with the signal connecting port, a connection signal is produced, and when the microcontroller receives a ground signal, the microcontroller controls the power supply to make it provide power to the corresponding server.

According to yet another embodiment of the present invention, when the power connecting plug is pulled out of the power connecting socket, the connection signal disappears, and when the microcontroller does not receive the connection signal, the microcontroller controls the power supply to make it stop providing power to the corresponding server.

Thus, according to the technical contents of the present invention, the embodiments of the present invention provides a rack server device to solve the problem that a spark is produced when a server is directly pulled out of a rack.

It is to be understood that both the foregoing general description and the following detailed description are by examples, and are intended to provide further explanation of the invention as claimed.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a schematic view of a rack server device according to an embodiment of the present invention;

FIG. 2 is a schematic perspective view of the rack server, device in FIG. 1; and

FIG. 3 is a schematic view of a power connecting plug on a server according to another embodiment of the present invention.

### DETAILED DESCRIPTION

Hereinafter, the embodiments will be described in detail with reference to the accompanying drawings. However, the embodiments are not intended to limit the scope of the present invention, and the description of the operation of a structure is not used to limit its performing sequence. Any apparatus with equivalent functions that is produced from a structure formed by a recombination of elements shall fall within the scope of the present invention. The drawings are only for illustration and are not made according to original dimensions.

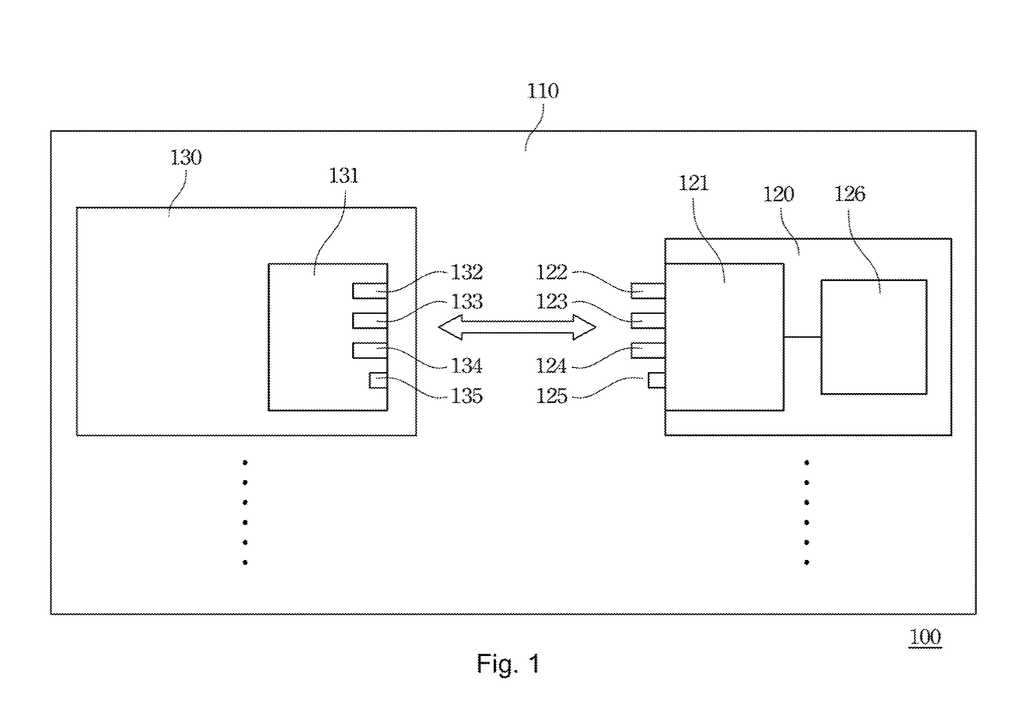

FIG. 1 is a schematic view of a rack server device 100 according to an embodiment of the present invention. The rack server device 100 includes a rack 110, a plurality of servers 120 and a plurality of power distribution units (PDUs) 130. Each of the servers includes a power supply 121 and a microcontroller 126. The server 120 is connected with the corresponding PDU 130 through the power supply 121, and the microcontroller 126 is operable to control the power supply 121 when the server 120 is connected with the corresponding PDU 130.

Furthermore, the power supply 121 includes a power connecting plug. The power connecting plug includes a positive pin 122, a negative pin 123, a ground pin 124 and a signal pin 125. In this embodiment, the signal pin 125 is shorter than the positive pin 122, the negative pin 123 and the ground pin 124.

Moreover, each of the PDUs 130 includes a plurality of power connecting sockets 131 (only one power connecting socket 131 is exemplarily shown in the figure). The power connecting socket 131 includes a positive connecting port 132, a negative connecting port 133, a ground connecting port 134 and a signal connecting port 135. The positive connecting port 132, the negative connecting port 133, the ground connecting port 134, and the signal connecting port 135 are operable to respectively connect to the positive pin 122, the negative pin 123, the ground pin 124, and the signal pin 125.

In manufacturing, in order to install the server 120 on the rack 110 in a direct plug-in and pull-out manner, the PDU 130 is configured at a rear side of the rack 110.

Moreover, the power connecting plug of the power supply 121 of the server 120 is designed so that it can be connected with the power connecting socket 131 of the PDU 130. In this way, the server 120 can be installed on the rack 110 in the direct plug-in and pull-out manner, without pulling the server out after a power cord disposed at the rear side of the rack server is detached first. Thus, by applying the embodiments of the present invention, when the server is repaired or disassembled, a trouble of detaching the power cord can be alleviated and therefore it is convenient and fast for a user to disassemble the server.

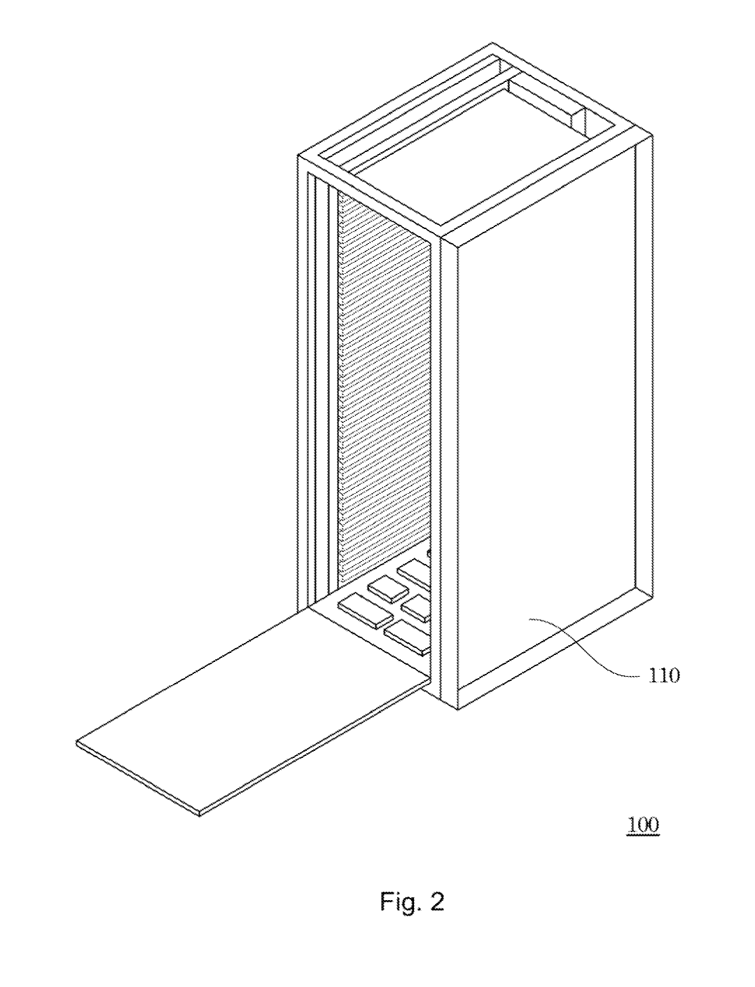

FIG. 2 is a schematic perspective view of the rack server device 100 in FIG. 1. The rack server device 100 includes the rack 110. As shown in FIGS. 1 and 2, the server 120 can be configured on the rack 110 in a direct plug-in manner or the server 120 can be directly pulled out of the rack 110.

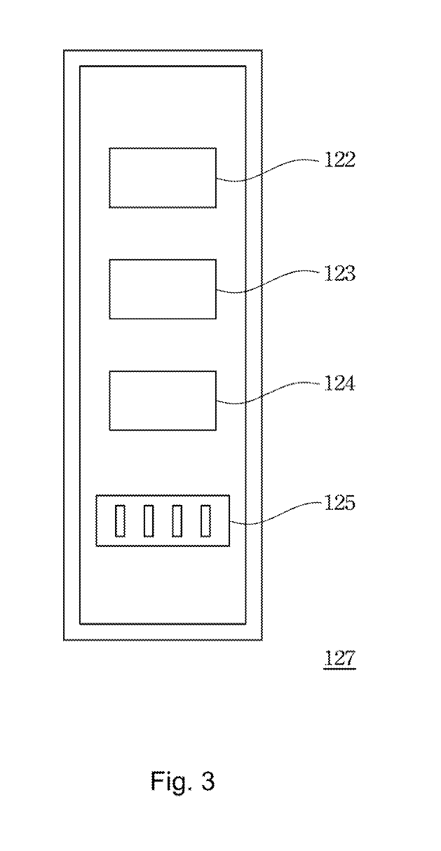

However, in the direct plug-in and pull-out manner used for the server, since the PDU 130 directly provides a certain voltage (e.g. a voltage of 380 V), a spark is produced when the power connecting plug on the server 120 is inserted into the power connecting socket 131 of the PDU 130 or when the power connecting plug on the server 120 is removed from the power connecting socket 131 of the PDU 130. In order to make the embodiments of the present invention more convenient in operation and also maintain the safety characteristic, the embodiments of the present invention include another technical feature for avoiding the spark, which will be described in detail in FIG. 3.

FIG. 3 is a schematic view of a power connecting plug 127 on a server according to an embodiment of the present invention. Refer to both FIGS. 1 and 3. The power connecting plug 127 includes the positive pin 122, the negative pin 123, the ground pin 124 and the signal pin 125. The corresponding positive connecting port 132, the corresponding negative connecting port 133, the corresponding ground connecting port 134 and the corresponding signal connecting port 135 are configured on the power connecting socket 131 of the PDU 130.

The signal pin 125 is shorter than the positive pin 122, the negative pin 123 and the ground pin 124.

Thus, when the power connecting plug 127 on the server is inserted into the power connecting socket 131 of the PDU 130, the positive pin 122, the negative pin 123 and the ground pin 124 are respectively connected with the positive connecting port 132, the negative connecting port 133 and the ground connecting port 134 first, and then the signal pin 125 is connected with the signal connecting port 135.

In contrast, when the power connecting plug 127 is pulled out of the power connecting socket, the signal pin 125 is disconnected from the signal connecting port 135 first, and then the positive pin 122, the negative pin 123 and the ground pin 124 are respectively disconnected from the positive connecting port 132, the negative connecting port 133 and the ground connecting port 134.

Specifically, in the embodiments of the present invention, in addition to using the characteristics of the above structures, a control on the circuit is provided to avoid the occurrence of a spark when power connecting plug 127 is connected with or disconnected from the power connecting socket 131. The circuit control mechanism of the embodiments of the present invention will be described hereinafter.

In operation, when the power connecting plug 127 is connected with the power connecting socket, the signal pin 125 is connected with the signal connecting port 135 and meanwhile the power supply 121 provides power to the corresponding server.

In contrast, when the power connecting plug 127 is pulled out of the power connecting socket 131, the signal pin 125 is disconnected from the signal connecting port 135 and meanwhile the power supply 121 stops providing power to the corresponding server.

Particularly, each of the servers 120 can further include the microcontroller 126 as shown in FIG. 1. The microcontroller 126 is operable to control the power supplies 121. When the signal pin 125 is connected with the signal connecting port 135, a connection signal is produced, and when the microcontroller 126 receives the connection signal, the microcontroller 126 controls the power supply 121 to make it provide power to the corresponding server.

Moreover, when the power connecting plug 127 is pulled out of the power connecting socket 131, the connection signal disappears, and when the microcontroller 126 does not receive the connection signal, the microcontroller 126 controls the power supply 121 to make it stop providing power to the corresponding servers.

In an embodiment, the ground connecting port 134 in the power connecting socket 131 is electrically connected with the signal connecting port 135. When the positive pin 122, the negative pin 123 and the ground pin 124 in the power connecting plug 127 are respectively connected with the positive connecting port 132, the negative connecting port 133 and the ground connecting port 134 in the power connecting socket 131 first, the signal of the signal pin 125 is a high-level signal. Then, when the signal pin 125 is connected with the signal connecting port 135, since the ground pin 124 is already connected with the ground connecting port 134, the signal of the signal pin 125 is changed into a low-level signal and meanwhile the power supply 121 is told to provide power to the corresponding server.

It should be noted that, when the signal pin 125 is not connected with the signal connecting port 135, although the positive terminal is already connected with the negative terminal, the current is very small and no spark will be produced because no load exists. Likewise, when the signal pin 125 is disconnected from the signal connecting port 135, the load is removed first so that the current at the positive terminal and the negative terminal becomes small, and thus no spark will be produced.

In another embodiment, the signal connecting port 135 of the PDU 130 can be in a ground state. Thus, when the signal pin 125 is connected with the signal connecting port 135, the produced connection signal is a ground signal. However, it is not intended to limit the present invention. People skilled in the art can adopt different manners to produce the preceding connection signal without departing from the spirit or scope of the present invention.

As can be known from the above embodiments of the present invention, applying the present invention has the following advantage. The present invention provides a rack server device to solve the problem that a spark is produced when a server is directly pulled out of a rack.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A rack server device, comprising:
a rack;
a plurality of servers configured on the rack, wherein each of the servers comprise's a power supply, and the power supply comprises:
a power connecting plug comprising a positive pin, a negative pin, a ground pin and a signal pin, wherein the signal pin is shorter than the positive pin, the negative pin and the ground pin;
a plurality of power distribution units (PDUs) configured on the rack, wherein each of the PDUs comprises:
a power connecting socket comprising a positive connecting port, a negative connecting port, a ground connecting port and a signal connecting port, wherein the positive connecting port, the negative connecting port, the ground connecting port, and the signal connecting port are operable to respectively connect to the positive pin, the negative pin, the ground pin, and the signal pin.

2. The rack server device of claim 1, wherein when the power connecting plug is connected with the power connecting socket, the signal pin is connected with the signal connecting port and meanwhile the power supply provides power to the corresponding server, and when the power connecting plug is pulled out of the power connecting socket, the signal pin is disconnected from the signal connecting port and meanwhile the power supply stops providing power to the corresponding server.

3. The rack server device of claim 1, wherein each of the servers further comprises:
a microcontroller which is operable to control the power supplies;
wherein when the signal pin is connected with the signal connecting port, a connection signal is produced, and when the microcontroller receives the connection signal, the microcontroller controls the power supply to make it provide power to the corresponding server.

4. The rack server device of claim 3, wherein when the power connecting plug is pulled out of the power connecting socket, the connection signal disappears, and when the microcontroller does not receive the connection signal, the microcontroller controls the power supply to make it stop providing power to the corresponding server.

5. A rack server device, comprising:
a rack;
a plurality of servers configured on the rack, wherein each of the servers comprises a power supply which comprises:
a power connecting plug comprising a signal pin;
a plurality of power distribution units (PDUs) configured on the rack, wherein each of the PDUs comprises:
a plurality of power connecting sockets, wherein each of the power connecting sockets comprises a signal connecting port;
wherein when the power connecting plug is connected with the power connecting socket, the signal pin is connected with the signal connecting port and meanwhile the power supply provides power to the corresponding server.

6. The rack server device of claim 5, wherein when the power connecting plug is pulled out of the power connecting socket, the signal pin is disconnected from the signal connecting port and meanwhile the power supply stops providing power to the corresponding server.

7. The rack server device of claim 5, wherein the power connecting plug further comprises a positive pin, a negative pin and a ground pin, wherein the signal pin is shorter than the positive pin, the negative pin and the ground pin.

8. The rack server device of claim 7, wherein the power connecting socket further comprises a positive connecting port, a negative connecting port and a ground connecting port, wherein the positive connecting port, the negative connecting port, the ground connecting port and the signal connecting port are operable to respectively connect to the positive pin, the negative pin, the ground pin and the signal pin.

9. The rack server device of claim 5, wherein each of the servers further comprises:
a microcontroller operable to control the PDUs;
wherein when the signal pin is connected with the signal connecting port, a connection signal is produced, and when the microcontroller receives the connection signal, the microcontroller controls the power supply to make it provide power to the corresponding server.

10. The rack server device of claim 9, wherein when the power connecting plug is pulled out of the power connecting socket, the connection signal disappears, and when the microcontroller does not receive the connection signal, the microcontroller controls the power supply to make it stop providing power to the corresponding server.
